(19) United States
(12) Patent Application Publication
(10) Pub. No.: US 2018/0222146 A1
(43) Pub. Date: Aug. 9, 2018

(54) STRENGTH ENHANCING LAMINAR COMPOSITE MATERIAL PLY LAYER PRE-FORM AND METHOD OF MANUFACTURING THE SAME

(71) Applicant: University fo Massachusetts, Boston, MA (US)

(72) Inventors: John M. Rice, Portsmouth, RI (US); Armand F. Lewis, Mattapoisett, MA (US); Yong K. Kim, N. Dartmouth, MA (US)

(21) Appl. No.: 15/942,770

(22) Filed: Apr. 2, 2018

Related U.S. Application Data
(63) Continuation-in-part of application No. 14/642,987, filed on Mar. 10, 2015.

(51) Int. Cl. B32B 5/12; B32B 5/10; B32B 7/12; B32B 5/02; C09J 5/00; B32B 37/12

(52) U.S. Cl. CPC B32B 5/12; B32B 2037/1253; B32B 7/12; B32B 5/024; B32B 5/022; B32B 5/026; C09J 5/00; B32B 37/12; B32B 2255/26; B32B 2255/02; B32B 2262/101; B32B 2262/106; B32B 2262/00; B32B 2307/72; B32B 2305/08; C09J 2433/00; C09J 2475/00; C09J 2463/00; B32B 5/10

(57) ABSTRACT

Various embodiments of a strength enhancing pre-form material ply layer which include a fibrous laminar base-ply substrate comprising a plurality of crossed elements forming a plurality of interstices; a thin adhesive sizing layer disposed on surfaces of the fibrous laminar base-ply substrate such that the plurality of interstices remain open to receive embedded fibers; and a plurality of reinforcing fibers are disclosed. These layers can be assembled into an Organic Polymer Laminar Composite (OPLC) structure, the reinforcing fibers impart greatly improved inter-laminar shear strength and toughness to the OPLC final structures.

### RELATED APPLICATION(S)

This application is a continuation in part of U.S. patent application Ser. No. 14/642,987, filed on Mar. 10, 2015, entitled Structured Fiber Reinforced Layer. This application is related to U.S. Provisional Patent Application Ser. No. 60/863,680, filed on Oct. 31, 2006, entitled “Fabric Based Laminar Composite and Method for Manufacture Thereof,” and U.S. patent application Ser. No. 11/931,416, filed on Oct. 31, 2007, entitled “Materials Methodology To Improve The Delamination Strength Of Laminar Composites,” issued as U.S. Pat. No. 7,981,495 on Jul. 19, 2011. The entire teachings and contents of these Patent Applications are hereby incorporated by reference herein in their entirety.

### FIELD OF USE

The present disclosure relates to inter-laminar Z-Axis oriented fiber surfaced composite ply layer reinforcement material that when laid up in a composite assembly will greatly enhance the interlaminar shear strength and fracture toughness of Organic Polymer Laminar Composite (OPLC) materials.

### BACKGROUND

Delamination of layered fabric-reinforced composites rep s one of the most prevalent structural, life-limiting failure modes of such materials. As an example, Organic Polymer Laminar Composite (OPLC) materials based on layered fabrics have many advantageous property and processing features. However, one structural drawback is their generally poor interlaminar shear strength. Layered OPLCs have little or no fiber reinforcement in a thickness direction. Therefore, their inter-ply strength is less than their longitudinal strength which can result in poor impact and/or inter-laminar flexural fatigue strength.

Various techniques have been introduced to enhance the inter-laminar strength of layered composite materials. A common technique is to use a rubber-toughened matrix material resin. However, these resins are generally not thermally durable. An alternative approach is to manufacture special pre-forms using advanced textile technologies such as 3-D knitting/weaving/braiding or through-the-fabric stitching/pinning processes. However, these methods are slow, inefficient, and expensive. While fabricated pre-forms may include yarns in a z-directional orientation, these reinforcements are generally not conducive to air optimized stress distribution in the mechanically functioning structure component. Such 3-D structures are prone to stress concentrations under mechanical service leading to poor fatigue resistance. These approaches appear to work in their primary goal, but they degrade the composite's in-plane properties.

Furthermore scientific publications by Kim et al., “Fracture Toughness of Flock Reinforced Layered Composites”, Proceedings of 1^{st} Industrial Simulation Conference 2003, June 9-11, UPV, Valencia, Spain, p. 477-482 (2003) and Kim et al., “Through-Thickness Reinforcement of Laminar Composites”, Journal of Advanced Materials”, Vol. 36, no. 3, July 2004, pp 25-31, the entirety of these references hereby incorporated herein by reference, disclose that composites reinforced with z-directional fibers appear to have the potential to exhibit improved inter-laminar strength. However, z-directional reinforcement remains highly unpredictable due to the large number of variables (e.g., fiber type, Z-Axis oriented fiber density (the number of perpendicularly oriented fibers per unit area of interface between the substrates), fiber denier (mass in grams per 9000 m), fiber length, binder resin type, bonding strength between fiber and binder resin, etc.) present in such a composite. As a result, many such composites do not show improved inter-laminar shear properties and/or suffer a decrease in toughness.

Several methods are available to incorporate Z-Axis oriented short fibers into the surface of planar fabric surfaces. One common textile process to do this is the textile “pile” process which is used to manufacture carpets, velvets or velours by weaving or knitting. Textile “pile” processing is capable of creating fibrous surfaces with a high, close-packed arrangement of upright fibers. Another common textile methodology for applying Z-Axis oriented fibers to fabric surfaces is the flocking process.

Interlayer reinforcing fibers are re-arranged or placed so that they can bridge across the laminar plies in a thickness direction. This could lead to a more structurally isotropic laminate. In pursuing this approach, special pre-form fabrics were fabricated ⁻using advanced textile technologies such as multi-directional knitting, 3-D weaving or through-the-fabric stitching and pinning processes. While these methods are found to be slow, they resulted in the desired 3-D orientation of yarn fibers in the reinforcing fabric's structure. Unfortunately, these methods are very expensive as well as design restrictive; they also have scalability difficulties. Furthermore, these 3-D fiber orientations are usually not conducive to optimized strength utilization of the parent yarn due to the obliqueness at the yarn structure's interlacing points. Therefore, some of these 3-D structures are prone to stress concentrations under mechanical service leading to poor fatigue resistance. All these approaches work in their special application area but in many cases they often degrade the composite's in-plane properties. This is especially true for the through-thickness textile stitching methods. Therefore, there is a need in the art for a composite showing improved characteristics such as inter-laminar shear strength and/or fracture toughness and corresponding sub-structures which facilitate the manufacture of these composites.

Referring to some conventional flocking methods which are not related to interlaminar shear strength and toughness of Organic Polymer Laminar Composite (OPLC) materials or precursor layered composite materials, U.S. Pat. No. 2,999,763 issued to Sommer teaches a method of applying flock to a fabric using a foam adhesive, such that when the fiber flocked surface is finally cured, the air bubbles in the foam adhesive are allowed to collapse by heat curing or vulcanization, rendering the final flocked fabric layer material permeable to air. This allegedly leads to the creation of a more comfortable wearing and breathable garment fabric but is not a precursor layered composite material and therefore does not improve to interlaminar shear strength. An important issue of consideration in this process is the nature of the rubber latex foam that is used by Sommer. This foam material must be so formulated so the air bubbles in the wet un-vulcanized foam have (a) no excessive skin formation prior to the application of the fibers that would prevent the initial penetration of the fibers into the foam adhesive, (b) the foam's air bubbles must collapse during the heat applied vulcanization step and (c) the undesired excessive penetration of the fluid foam adhesive into the support (fabric) material. Deep penetration of the foam flock adhesive into the support fabric would cause a thinning of the adhesive layer and would be detrimental to the fixation of the fibers. The final fabric product disclosed by Sommer is a utilitarian flock fiber surfaced garment fabric having full, pass through, air permeability. The fibers must be fully and durably secured to the support fabric such that the flocked fabric retains flexibility and the adhesive must resist dry cleaning by use of solvents (dry-cleaning solvents). The flock fibers are therefore permanently bonded to the support fabric as an integral part of a final product.

### SUMMARY

Various embodiments of structured fiber reinforced layers include fibrous organic polymer composite reinforcing materials that have been “pre-flocked” with Z-Axis reinforcing fibers. These “pre-flocked” fibrous support materials (woven, knitted, mat, nonwoven or pre-pregs) are then supplied as “off-the-shelf,” “ready-to-use,” already flocked reinforced, dry to the touch, pre-manufactured, storable, inventoried organic polymer composite structured fiber reinforcing layers that are ready as needed to be laid-up and impregnated with matrix resin and cured to form a shear strength enhanced OPLC.

In one embodiment, a strength enhancing material ply layer pre-form includes a fibrous laminar base-ply substrate comprising a plurality of crossed elements forming interstices, an adhesive layer disposed on surfaces of the plurality of crossed elements of the fibrous laminar base-ply substrate and a plurality of reinforcing fibers oriented vertically to a top surface of the fibrous laminar base-ply substrate and embedded into the plurality of interstices formed by the plurality of crossed elements and below the top surface of the fibrous laminar base-ply substrate. In this embodiment, the adhesive layer facilitates embedding the plurality of reinforcing fibers into the interstices, the plurality of reinforcing fibers are bound to the surfaces of the plurality of crossed elements by the adhesive layer for subsequent composite ply material assembly and the fibrous laminar base-ply substrate remains flexible and resin permeable to conform to contour layups. Such a pre-form increases fracture toughness of a final composite material. Such a strength enhancing material ply layer pre-form also provides a more “consumer(manufacturer)-friendly” approach to the Z-axis laminar ply reinforcement technology, whereby reinforcing fibers are tacitly applied to individual “dry” pre-form fibrous laminar ply layers to form a “stand-alone” inter-laminar reinforced pre-form layer material. In some embodiments the orientation of the reinforcing fibers is not critical for fracture toughness.

In embodiments disclosed herein, the pre-form crossed elements can include a plurality of individual filaments, a plurality of filament yarns, a plurality of individual filaments and a plurality of filament yarns or a plurality of filaments oriented in warp and weft directions.

In another embodiment, the adhesive layer includes an uncured softened B-staged epoxy matrix outer surface having a lower viscosity forming a tacky surface to receive embedded reinforcing fibers. In yet another embodiment, the pre-form adhesive layer includes a thin adhesive sizing layer disposed on surfaces of the fibrous laminar base-ply substrate such that the plurality of interstices remain open to receive embedded upright reinforcing fibers.

In embodiments disclosed herein, individual fibrous laminar base-ply fabric substrates organic polymer composites are flocked with short Z-Axis (vertically oriented) reinforcing fibers. In one embodiment, a structured fiber reinforced layer (referred to as TYPE 1) includes a fibrous laminar base-ply substrate comprising a plurality of filament yarns (e.g., advanced base-ply substrate pre-forms or multi-strand linear bundles of monofilament or staple fibers wound together to form a thread) forming a plurality of interstices, a thin adhesive sizing layer disposed on the fibrous laminar base-ply substrate, a plurality of reinforcing fibers, a majority of which are oriented substantially perpendicular to a first surface of the fibrous laminar base-ply substrate, the substantially perpendicularly oriented reinforcing fibers being partially embedded in the plurality of interstices, wherein the plurality of reinforcing fibers are to surfaces of the plurality of filament yarns by the thin adhesive layer for subsequent composite ply material assembly and the sized and flocked fibrous laminar base-ply support substrate remains flexible to conform to contour layups. Such reinforced layers can be combined to produce Z-directional fiber reinforced composites exhibiting enhanced properties (e.g., inter-laminar strength, toughness).

In another embodiment, a structured fiber reinforced layer (referred to as TYPE 2) includes a pre-preg composite reinforcement ply layer structure, including a B-staged epoxy matrix outer surface; a plurality of reinforcing fibers, a majority of which are oriented substantially perpendicular to a first surface of the pre-preg composite reinforcement ply structure, the substantially vertically oriented reinforcing fibers being partially embedded in the B-staged epoxy matrix outer surface of the B-staged epoxy resin pre-preg composite reinforcement ply structure, wherein the plurality of reinforcing fibers are secured in place within the B-staged epoxy matrix outer surface for subsequent composite ply material assembly and the pre-preg composite reinforcement ply structure remains flexible to conform contour layups. Since these pre-preg composite ply layers are composed of fibrous woven, knitted, mat or unidirectional fiber orientation materials that are impregnated (bound together) with latent curing epoxy resins, these Type 2 pre-flocked systems are generally stored and shipped under cold (dry-ice) temperature conditions.

In another embodiment, a technique for fabricating a fiber composite reinforcement layer includes applying a thin coating of resinous flock adhesive sizing to a dry substrate, the dry substrate comprising a plurality of filament yarns forming a plurality of interstices and flocking a plurality of reinforcing fibers onto a first surface of the sized dry substrate. Flocking includes embedding the plurality of reinforcing fibers into the plurality of interstices while the resinous flock adhesive sizing is still fluidic and uncured and attaching the plurality of reinforcing fibers to surfaces of the plurality of filament yarns by curing the adhesive sizing.

In yet another embodiment, a technique for fabricating a fiber composite reinforcement layer includes providing a pre-preg composite reinforcement ply structure, including B-stage epoxy matrix, softening the B-stage epoxy matrix of the pre-preg composite reinforcement ply structure to lower a B-stage epoxy matrix viscosity forming a tacky surface; and flocking a plurality of reinforcing fibers onto a first surface of the pre-preg composite reinforcement ply structure such that the plurality of reinforcing fibers penetrate an outer surface of the B-staged epoxy matrix.

Both TYPE 1 and TYPE 2 pre-flocked fibrous reinforcing layers provide the material for fabricating high laminar shear strength organic polymer composites which have many applications. Potential applications include: aerospace, aircraft, marine structures, ship hulls, military ballistic plate/panel manufacture and many other applications. Embodiments of Z-Axis pre-flocked fibrous reinforcing layers allow composite structure/product manufacturers to avoid getting involved with the intricacies of the flocking processes within their manufacturing plant or operation. Compared to conventional non-Z-axis reinforced composites, composites fabricated with pre-flocked fibrous reinforcing layers have an increase in inter-laminar shear strength. When manufacture design and fabricate laminar composites using pre-flocked fibrous reinforcing layers lay-up, the inter-laminar plies of the finished composite lay-up will be rendered Z-axis reinforced. A manufacturer does not have to have their own flocking capability or be concerned with flocking quality when using TYPE 1 and TYPE 2 pre-flocked fibrous reinforced/reinforcing layers disclosed herein.

Various embodiments of a base fabric or mat fibrous composite reinforcement ply layer material have Z-Axis short fibers deposited onto these basic composite ply layer materials by textile flocking. When these “pre-flocked” base fabric layers are assembled into an Organic Polymer Laminar Composite (OPLC) structure, the Z-Axis implanted short fibers impart greatly improved inter-laminar shear strength and toughness to these load bearing structures. These “pre-flocked” fibrous materials (woven, knitted, mat, nonwoven or pre-pregs) are then supplied as “off-the-shelf,” “ready-to-use,” already flock reinforced, dry to the touch, pre-manufactured, storable, inventoried organic polymer composite structured fiber surfaced composite ply-layer reinforcement material is readily available for standard wet-lay-up assembly and consolidation into a shear toughened OPLC structure. The matrix resin is cured to form fiber based z-directional interlayer located reinforced composites having enhanced inter-laminar strength, impact toughness, transmission properties (electrical and thermal conduction) and coefficient of thermal expansion are provided. Methods for forming such ‘pre-flocked” future OPLC, Z-Axis reinforcement layers are also provided.

### BRIEF DESCRIPTION OF THE DRAWINGS

The foregoing and other objects, features and advantages of the invention will be apparent from the following more particular description of embodiments of the invention, as illustrated in the accompanying drawings and figures in which like reference characters refer to the same parts throughout the different views. The drawings are not necessarily to scale, with emphasis instead being placed upon illustrating the embodiments, principles and concepts of the invention. These and other features of the invention will be understood from the description and claims herein, taken together with the drawings of illustrative embodiments, wherein:

FIG. 1A schematically illustrates an exemplary embodiment of multiple structured fiber reinforced layers before being combined to form a z-directional fiber based reinforced composite;

FIG. 1B schematically illustrates the multiple structured fiber reinforced layers of FIG. 1 after being combined to form a z-directional fiber based reinforced composite;

FIG. 1C schematically illustrates an exemplary embodiment of a double sided structured fiber reinforced layer;

FIG. 1D schematically illustrates an exemplary embodiment of the double sided structured fiber reinforced layer of FIG. 1D, inter-layered or inter-leaved with non-structured flock reinforced fibrous layers;

FIG. 2 is a side view of an exemplary embodiment of a dry substrate structured fiber reinforced layer;

FIG. 3 is a cross sectional view (along section 3-3) of the dry substrate structured fiber reinforced layer of FIG. 2 showing a thin adhesive sizing layer disposed on the dry fibrous laminar base-ply substrate;

FIG. 4 is a side view of an exemplary embodiment of a pre-preg substrate structured fiber reinforced layer;

FIG. 5 is a cross sectional view (along section 5-5) of the pre-preg substrate structured fiber reinforced layer of FIG.4 showing the fibers embedded in the B-staged epoxy matrix of the pre-preg fibrous laminar base-ply substrate;

FIG. 6 is a top view of an exemplary embodiment of a woven dry substrate structured fiber reinforced layer showing a thin adhesive sizing layer disposed on the dry fibrous laminar base-ply woven substrate; and

FIG. 7 is a cross sectional view (along section 7-7) of the woven substrate of FIG.6 showing the fibers embedded below a top surface of the woven substrate.

### DETAILED DESCRIPTION

Certain exemplary embodiments will now be described to provide an overall understanding of the principles of the structure, function, manufacture, and use of the reinforced layers and methods of fabrication disclosed herein. One or more examples of these embodiments are illustrated in the accompanying drawings. Those skilled in the art will understand that the reinforced layers and methods specifically described herein and illustrated in the accompanying drawings are non-limiting embodiments and that the scope of the present disclosure is defined solely by the claims. The features illustrated or described in connection with one embodiment may be combined with the features of other embodiments. Such modifications and variations are intended to be included within the scope of the present disclosure.

In general, the present disclosure provides strength enhancing material ply layer pre-forms specifically configured and optimized to allow manufacturers to employ flocked Z-Axis reinforced layer materials without getting involved with any in the intricacies of flocking processes within their manufacturing plant or operation. Off-the-shelf availability of Z-Axis fiber modified organic polymer fibrous reinforcing materials is facilitated by embodiments disclosed herein.

The inventors have discovered that fracture toughness (inter-laminar shear strength) of organic polymer laminar composites (OPLC) can be improved by applying Z-Axis oriented fibers to the interfacial zones of the composites and have demonstrated several Z-Axis reinforcement application processes functionally applicable to their use in OPLC fabrication. In one embodiment, a “pre-flocking” process is an efficient technique for introducing Z-Axis fibers into a fabricated OPLC.

It is understood that a pre-flocked pre-form is not a finished flock product. It is rather intended as an intermediate product for advanced composite manufacturers who do not or cannot produce flocked pre-form for their delamination resistant advanced laminar composite products. In one embodiment, this approach to Z-axis laminar ply reinforcement technology applies reinforcing fibers by embedding and tacking the fibers to individual “dry” fibrous laminar pre-form ply layers to form a “stand-alone” composite ply layer material. This is accomplished by first applying a very thin sizing resin (wet and uncured) to a fibrous reinforcing (fabric or mat) ply just before flocking. Allowing this thin resin sizing layer to cure in place serves to loosely secure the vertically oriented reinforcing fibers in place. These flocked composite reinforcement layers are now ready for subsequent composite ply material assembly manipulation; this includes gentle material handling, long-term storage, materials packaging and manipulation as it is to be subsequently used to fabricate a laminate. Since this process involves applying the vertically oriented reinforcing to available composite reinforcement materials, this process is referred herein as a “pre-flocking” technique. The sizing is cured after the reinforcing fibers are flocked This curing secures the attached flock fibers in place for their subsequent handling, storing, shipping and lay-up maneuvering.

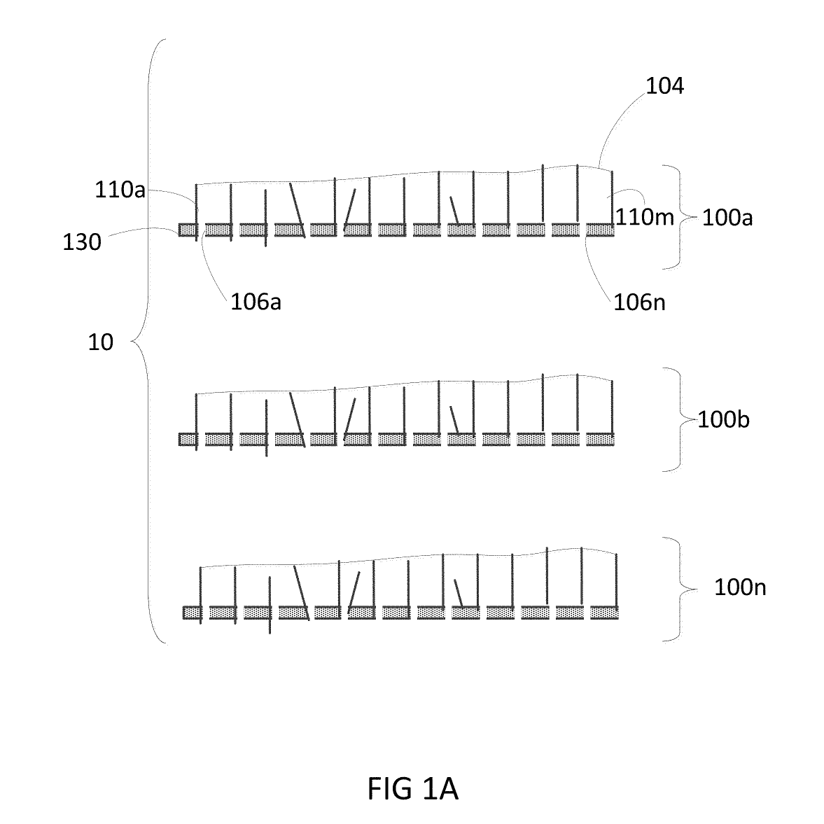

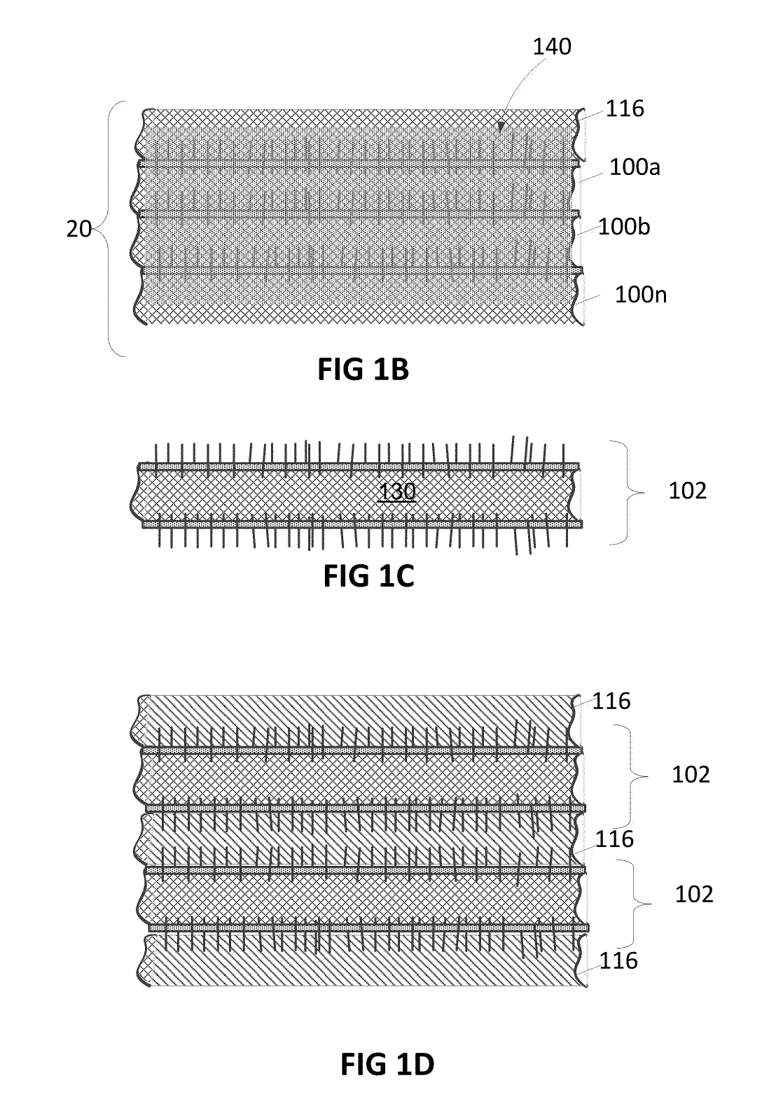

Now referring to FIG. 1A, a composite 10 (shown before being laid up) includes multiple strength enhancing material ply layer pre-form layers 100a-10On (commonly referred to as pre-form 100). Each pre-form 100 includes a fibrous laminar base-ply substrate 130. The fibrous laminar base-ply substrate 130 includes crossed elements (shown in FIGS. 3-5) forming interstices 106a-106n (collectively referred to as interstices 106). An adhesive layer (shown in FIGS. 3-5) is disposed on surfaces of the crossed elements of the fibrous laminar base-ply substrate 130. Reinforcing fibers 110a-110m (collectively referred to as reinforcing fibers 110) are oriented vertically to a top surface of the fibrous laminar base-ply substrate 130 and embedded into the interstices 106 formed by the plurality of crossed elements and below the top surface of the fibrous laminar base-ply substrate. In one embodiment, the vertically oriented reinforcing fibers are embedded into the interstices of the crossed elements of the fibrous laminar base-ply substrate to a depth of approximately about 0.05 to about 0.1 mm below the top surface of the fibrous laminar base-ply substrate. In various embodiments, the crossed elements form a woven laminar base-ply substrate, a non-woven laminar base-ply substrate or a knitted laminar base-ply substrate.

Here the layers 100 are shown with release sheets 104 disposed adjacent to the free ends of the reinforcing fibers 110. In one embodiment the release sheets include but are not limited to a thin, light-weight fabric lightly flocked with high denier packaging fibers and a thin, light-weight fabric lightly flocked with high denier packaging fibers. The high denier packaging fibers are longer and stiffer than the reinforcing fibers 110 positioned on the surface of the pre-flocked substrate layer.

The structured fiber reinforced layers for organic polymer laminar composites can be groups into two basic fibrous material types. TYPE-1: “Bare”, as-received from the textile mill, woven and knitted yarn fabrics, nonwoven fabrics and fibrous (open) mat products, and TYPE 2: so-called pre-preg composite reinforcing layers. The primary types of fibers that can be used to prepare TYPE 1 and TYPE 2 base “pre-flocked” reinforcing layers, include but are not limited to glass, carbon, polyaramid (Kevlar®) based textile fibers and generally yarns. In the TYPE 2 pre-flocks, the main resin composition here would be “B” staged epoxy resin—also the pre-preg's fiber yarn that is imbedded in the “B” staged epoxy resin is unidirectional yarn, woven fabric and chopped fiber mat type fiber reinforcement geometry. The methodology for fabricating TYPE 1 and TYPE 2 pre-flocked composite reinforcement entities is described below in more detail. “Pre-Flocking” of OPLC structured fiber reinforced layers before they are assembled into a laminar composite is an effective way of introducing flocked Z-Axis fibers into an OPLC structure.

FIG. 1B shows a finished OPLC after the release sheets have been removed, the layers 100 have been combined with a non-flocked substrate 116 and the combined laminar configuration 20 is then, in one embodiment, impregnated (throughout) with the liquid matrix resin 140 and this stack of Z-axis fiber reinforced fibrous plies are then consolidated by a vacuum bag or flat-press curing process.

FIG. 1C shows double-sided strength enhancing material ply layer pre-form 102 (also referred to as a double sided pre-flocked reinforcement fabric ply DSP). In one embodiment, a double-sided fiber structured reinforced layer is fabricated by applying an un-cured layer of adhesive sizing resin to both opposed surfaces of the substrate, and then flocking reinforcing fibers onto both opposed coated surfaces of a fibrous laminar base-ply substrate 130.

FIG. 1D shows the double-sided structured strength enhancing material ply layer pre-form 102 inter-layered (inter-leaved) with non-structured flock reinforced fibrous layers (SNF) 116 in an SNF/DSP/SNF/DSP/SNF lay-up configuration before a matrix resin is applied. It is understood that in various embodiments DSPs can be combined with SNF layers of different compositions and in different lay-up configurations. It is understood that the reinforcing fibers do not provide the actual reinforcement until the fibers are finally assembled into an OPLC.

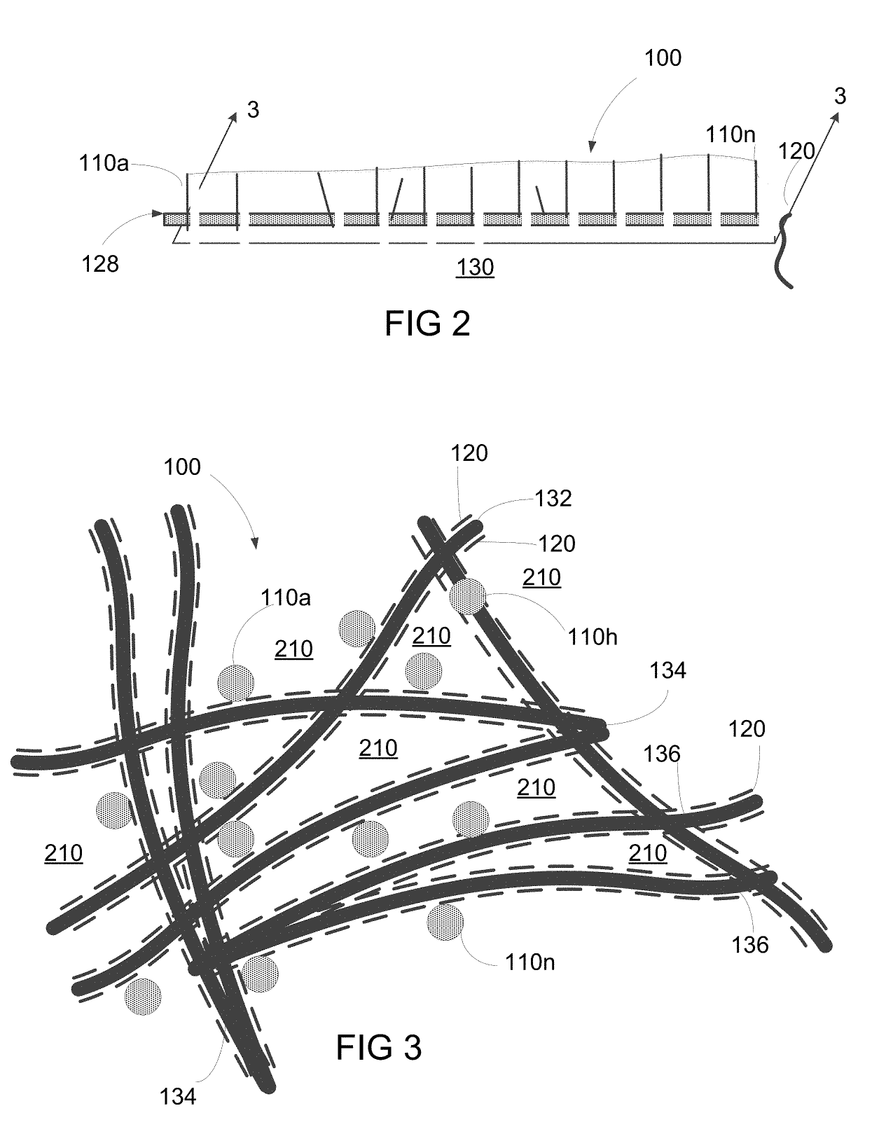

Now referring to FIG. 2, a strength enhancing material ply layer pre-form 100 includes a fibrous laminar base-ply substrate 130, an adhesive layer, here a thin adhesive sizing layer 120 disposed on the fibrous laminar base-ply substrate 130, a plurality of reinforcing fibers 110a-110n (collectively referred to as reinforcing fibers 110), a majority of which are oriented substantially perpendicular to a top surface 128 of the fibrous laminar base-ply substrate 130. In one embodiment, the fibrous laminar base-ply substrate 130 is a fibrous mat and in another embodiment it is similar to the non-flocked substrate 116. During the manufacturing process the a fibrous laminar base-ply substrate 130 is coated with a thin adhesive sizing layer 120 which in one embodiment is fluid before the fibers are attached and subsequently cured to attach the fibers in place. In one embodiment, the thin adhesive sizing layer is a resin, including but not limited to a sprayable polyurethane lacquer coating, a sprayable epoxy-based lacquer coating, a sprayable water based acrylic adhesive, a dilute water dip-able, water based acrylic adhesive and a dilute solvent based dip-able resin/lacquer coating system. In one embodiment, the adhesive layer facilitates embedding the plurality of reinforcing fibers into plurality of interstices by forming a thin sizing layer such that the interstices remain open to receive embedded reinforcing fibers. In this embodiment the reinforcing fibers 110 are embedded into the interstitial space below the top surface of the fibrous laminar base-ply substrate 130 and tacked to side surfaces of the plurality of crossed elements of the fibrous laminar base-ply substrate 130.

In one embodiment, the flock density of the reinforcing fibers is about 70 fibers/mm² to about 200 fibers/mm². In another embodiment, the reinforcing fibers have an average fiber length of about 0.5 mm to about 2.0 mm. In yet another embodiment, the reinforcing fibers have an average fiber fineness of about 1.0 denier to about 20 denier. The fibers include, but are not limited to synthetic fibers, glass fibers, carbon fibers, natural fibers, and metal fibers.

An exemplary manufacturing process generally includes applying a thin coating of resinous flock adhesive sizing to a dry fibrous substrate and flocking a plurality of reinforcing fibers onto a first surface of the sized dry substrate. The dry substrate includes a plurality of filament yarns forming a plurality of interstices. The flocking step includes embedding the reinforcing fibers into the interstices and attaching the plurality of reinforcing fibers to surfaces of the plurality of filament yarns while the resinous flock adhesive sizing is still fluidic and uncured. Flocking the reinforcing fibers can be accomplished by various techniques including, but not limited to, vacuum assisted flocking (VAF), shaking and vibration assisted flocking (SAF) and a combination of VAF and SAF,) alternating current flocking (ACF) combined with SAF, direct current (DC) high voltage assisted flocking (DCF) and a combination of DCF and SAF. In contrast to ACF which employs only a gravitational dropping force 1 g (where g is a normalized force with respect to mass), in one embodiment, DCF flocking uses electrostatic forces which exert a flocking force approximately 100 times greater than ACF to embed the reinforcing fibers. ACF flocking alone does not provide enough embedding force. In one embodiment a flocking force greater than ACF is used. In another embodiment, ACF is augmented by mechanical vibration force of a “beater” bar. The beater bar generates about two-four g of additional force. This minimum embedding force which is approximately a three to five g force can also be used to embed the reinforcing fibers in certain applications. In another embodiment the reinforcing fibers are flocked with a force of at least 100 g using DCF.

### The Resinous Flock Adhesive Sizing Includes, but is not Limited to:

a water based acrylic adhesive;
a sprayable polyurethane lacquer coating;
a sprayable epoxy-based lacquer coating;
a sprayable water based acrylic adhesive;
a dilute water dip-able, water based acrylic adhesive; and
a dilute solvent based dip-able resin/lacquer coating system.
In one embodiment, applying a thin coating of resinous flock adhesive sizing to the dry substrate includes applying uncured resinous flock adhesive sizing such that a thicknesses of the thin adhesive sizing layer ranges from about 0.01 mm to about 0.05 mm. In one embodiment, the application of the adhesive includes spraying the resinous flock adhesive sizing.

FIG. 3 shows a cross sectional view (along section 3-3) of the strength enhancing material ply layer pre-form layers 100 of FIG. 2 showing a thin adhesive sizing layer 120 disposed on the dry fibrous laminar base-ply substrate 130. In this embodiment the dry fibrous laminar base-ply substrate 130 includes multiple filament yarns 134 which can have multiple filaments 136 and can also have individual filaments 132 forming multiple interstices 210. The substantially perpendicularly oriented reinforcing fibers 110 are partially embedded in the plurality of interstices 210. Some reinforcing fibers (e.g., reinforcing fiber 110h) are attached to a top surface of the filaments 132 or yarns 134 of the dry fibrous laminar base-ply substrate 130. The reinforcing fibers 110 are attached to surfaces of the plurality of filament yarns 134, and filaments 132 by the thin adhesive sizing layer 120 for subsequent composite ply material assembly. The amount of adhesive sizing and processing of the pre-form 100 allows the pre-form 100 (i.e., the sized and flocked fibrous laminar base-ply substrate) to remain flexible, open and porous to conform to contour-shaped layups.

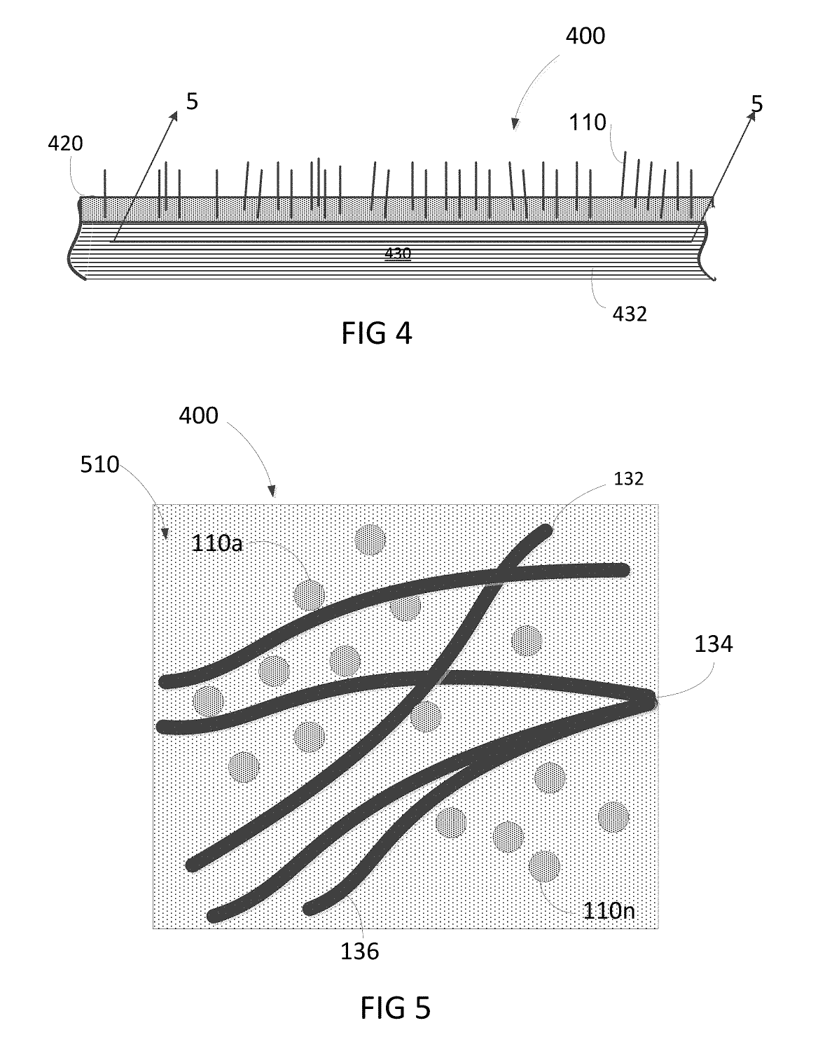

Now referring to FIG. 4, a strength enhancing material ply layer pre-form 400(commonly referred to as pre-form 400) similar to the pre-form 100 of FIG. 2 includes a pre-preg fibrous laminar base-ply substrate 430, a B-staged epoxy matrix outer surface 420 of the pre-preg fibrous laminar base-ply substrate 430, reinforcing fibers 110, a majority of which are oriented substantially vertically to an outer surface 420 of the pre-preg fibrous laminar base-ply substrate 430. During the manufacturing process the pre-preg fibrous laminar base-ply substrate 430 is processed such that the reinforcing fibers 110 are partially embedded in the B-staged epoxy matrix outer surface 420. In one embodiment, the matrix outer surface 420 (top layer) of the pre-preg fibrous laminar base-ply substrate 430 includes a portion of a B-staged epoxy matrix of the pre-preg fibrous laminar base-ply substrate 430 which has been processed (e.g., by careful heating) so that the reinforcing fibers 110 can be embedded (by flocking) into the pre-preg fibrous laminar base-ply substrate 430.

FIG. 5 shows a cross sectional view (along section 5-5) of the pre-form 400 of FIG.4 showing the B-staged epoxy matrix outer surface 420 on the dry fibrous laminar base-ply substrate 130. In this embodiment the pre-preg fibrous laminar base-ply substrate 430 includes multiple filament yarns 134 which can have multiple filaments 136 and can also have individual filaments 132 embedded in B-staged epoxy matrix 432. The substantially perpendicularly oriented reinforcing fibers 110 are partially embedded in the B-staged epoxy matrix outer surface 420 for subsequent composite ply material assembly. The structured fiber reinforced layer 400 is processed to remain flexible in order to conform to contour layups.

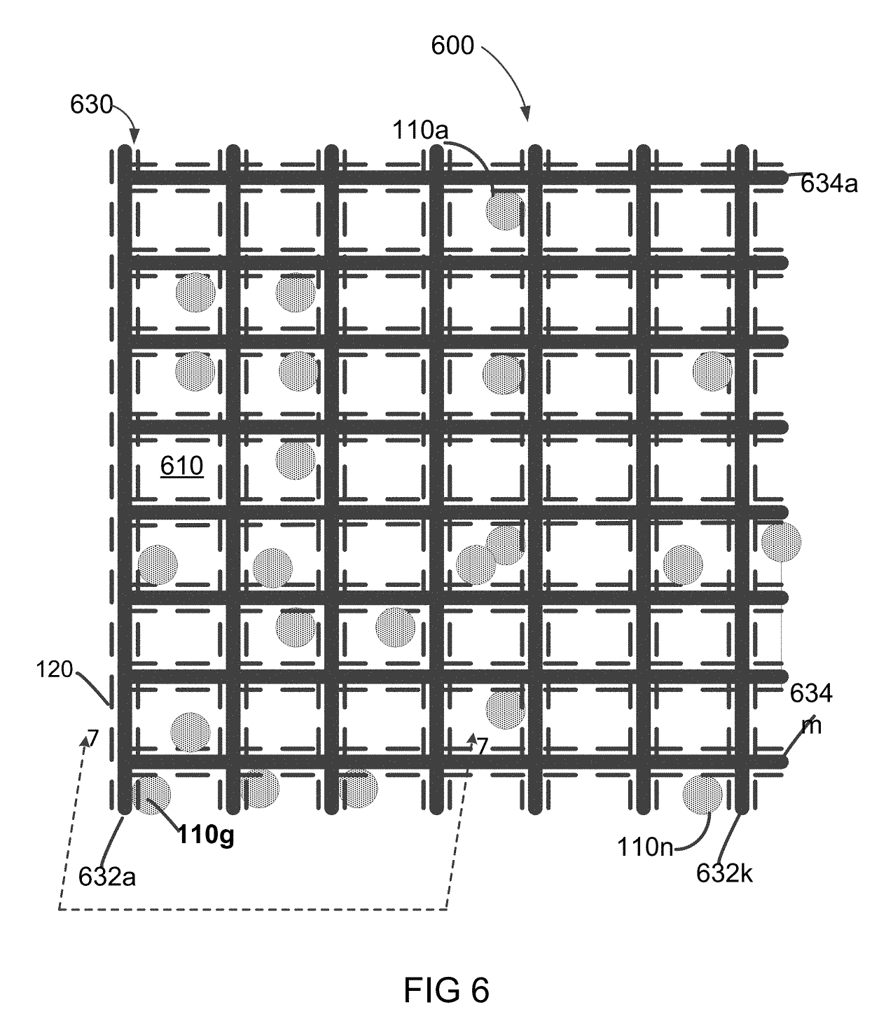

Now referring to FIG. 6, a pre-form 600 similar to the pre-form 100 of FIG. 2 includes a plurality of filaments oriented in warp and weft directions to form a woven fibrous laminar base-ply substrate 630 including weft fibers 634a-634m (collectively referred to as weft fibers 634) and warp fibers 632a- 632k (collectively referred to as warp fibers 632) forming interstices 610, a thin adhesive sizing layer 120 disposed on the woven fibrous laminar base-ply substrate 630, a plurality of reinforcing fibers 110a-110n (commonly referred to as reinforcing fibers 110), a majority of which are oriented vertical to the woven fibrous laminar base-ply substrate 630. During the manufacturing process the fibrous laminar base-ply substrate 130 is coated with a thin adhesive sizing layer 120.

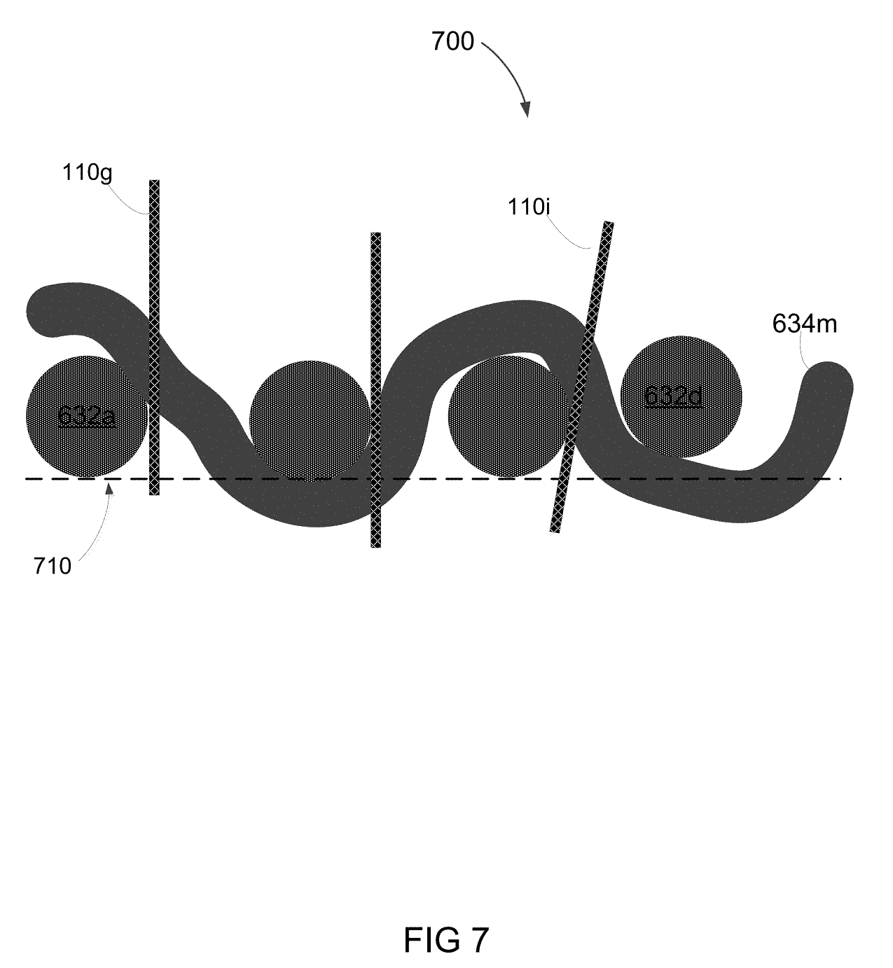

FIG. 7 shows a cross sectional view (along section 7-7) of the woven substrate 630 of FIG. 6 showing the reinforcing fibers 110g- 110i embedded below a top surface 710 of the woven substrate 630. The top surface 710 is above the lowest top surface of both the weft fibers 634 and warp fibers 632 in two dimensions (shown here above weft fiber 634m in one dimension). The reinforcing fibers are generally oriented vertically to a top surface of the fibrous laminar base-ply substrate and embedded into the plurality of interstices formed by the plurality of crossed elements and below the top surface of the fibrous laminar base-ply substrate by weaving operation.

### Dry Substrate and Pre-preg Embodiments

Z-Axis “pre-flocked” structured fiber reinforced layers can be grouped into two base/substrate fibrous material types. The structural and composition details and the fabrication methodology for these two exemplary types of pre-flocked structured fiber reinforced layers are described in more detail below.

### Pre-flocked Type 1

The primary types of fibers that can be used to prepare TYPE 1 base “pre-flocked” reinforcing/flock support layers are glass, carbon, polyaramid (Kevlar®) based textile fibers and yarns. Reinforcing fibrous “geometries” that can be pre-flocked include: fibrous mats (long fiber and short fiber), woven and knitted fabrics, and loosely consolidated nonwoven fabrics. Reinforcing fibers that can be pre-flocked include, but are not limited to: nylon, polyester, carbon, graphite, metal and polyolefin.

### Pre-flocked Preparation Methodology:

Exemplary TYPE 1 fibrous base reinforcement materials include reasonably-loose, consolidated, breathable, semi-open fiber structures. In one embodiment the fibrous substrate includes interstices (e.g., an open mesh texture) so that the reinforcing fibers 110 can penetrate into the fibrous structure. The deeper the reinforcing fibers 110 are embedded into the fibrous base material structure the stronger the reinforcing effect is achieved by these Z-Axis reinforcing fibers 110 when subsequently used in fabricating composite materials.

The Following are Exemplary Steps for Preparing Pre-flocked TYPE 1 Structured Biber Reinforced Layers:

(a) Apply thin not yet cured adhesive sizing resin layer onto the fibrous laminar base-ply substrate 130. This step sizes (e.g., lightly coats) the fibrous laminar base-ply substrate with a thin resinous (e.g., sticky) coating. One principle of fabricating pre-flocked Type 1 structured fiber reinforced layers is to flock these “bare” structured fiber reinforced layer using a thin adhesive sizing layer. The thin adhesive sizing layer will serve to attach these Z-Axis reinforcing fibers 110 in an upright position during the flocking process. These reinforcing fibers 110 are attached to the substrate surface (e.g., sides and top surfaces to the filaments and yarns) such that the reinforcing fibers 110 will not shake or drop off or shed the surface during normal packaging, storing, shipping, typical handling and fabrication lay-up manipulations. These reinforcing fibers 110 need not be attached to their substrate surface in a permanent manner. The adhesive sizing is also referred to as resinous coating materials or pre-fiber position-securing adhesives.

This use of the thin adhesive sizing coatings in the context of pre-flocked fibrous reinforcement layer are chosen to assure that the presence of the resinous coating does not adversely affect the mechanical properties of the final organic polymer engineering composite resin matrix material. Therefore, the polymer chemical nature of the pre-fiber adhesive sizing is selected to be compatible with the chemistry of the resinous matrix material. In various embodiments, polyurethane (spray-able) lacquer coatings have been successfully used. In other embodiments, an epoxy coating system, EV-400 Epoxy Varnish from Polyfiber Aircraft Coatings is used. Additionally water based acrylic adhesives are also used as a pre-fiber securing adhesive.

In one embodiment, the average thicknesses of the thin adhesive sizing layer disposed on the fibrous laminar base-ply substrate fabric ranges from about 0.017 mm to about 0.038 mm with an intermediate thickness of about 0.026 mm. This corresponds to an areal mass density of about 0.00002 gm/mm² to about an areal mass density of about 0.00004 gm/mm² with an intermediate areal mass density of about 0.000029 gm/mm²; where the mass or volume density of the epoxy varnish is about 0.00114 gm/mm³. The application of the sizing layer in the inventive embodiments is in contrast to conventional flocked fabrics where the entire top surface of the fabric is completely coated with an adhesive. Here the sizing is applied in a thin layer which leaves the interstitial space open so that the fiber can be embedded into the interstitial space and can be bonded to the top and side surfaces of the elements which form the fibrous laminar base-ply substrate fabric. This open structure also allows for better inter-penetration of the fluid matrix resin into the OPLC component ply layers during the lay-up of the final composite.

(b) Applying reinforcing fibers 110 onto the resin coated surfaces of the fibrous laminar base-ply substrate 130:

The elapsed time between adhesive size coating the fibrous laminar base-ply substrate 130 and flocking (applying) reinforcing fibers 110, in one embodiment, is kept to a minimum so that the reinforcing fibers 110 contact the resin coated surfaces of the fibrous laminar base-ply substrate 130 before the thin adhesive sizing layer dries or cures depending on the type of adhesive sizing. This is especially true if the size-coating resin system contains solvent or is solvent based. This applied resinous coating must be in a fluid “sticky” state when the flocking process commences. There is also the need for the reinforcing fibers 110 to penetrate as deeply as possible into the fibrous laminar base-ply substrate's structure. It is also desirable for the for reinforcing fibers to be applied at a low to moderate flock density, about 70 to about 200 fibers/mm². In addition to embedding the reinforcing fibers 110 it is understood that some of the reinforcing fibers 110 will be applied to top surfaces of the plurality of filament yarns in the fibrous laminar base-ply substrate 130. Each structured fiber reinforced layer remains flexible and resin permeable.

Several flock processing methods are used to assure the maximum penetration of the fibers into the fibrous laminar base-ply substrate's interstices. Exemplary processes are (1) Vacuum Assisted Flocking (VAF); (2) Shaking (or vibration) Assisted Flocking (SAF), and (3) a combination of VAF and SAF. Certain conventional flocking processes use “gravity flocking” which might not provide sufficient force to embed the fibers into the fibrous laminar base-ply substrate's interstices. Other conventional applications use alternating current(AC) flocking with relatively low voltage allowing the fibers to free fall perpendicular to the substrate with the acceleration of gravity (1G), while embodiments disclosed herein, use DC flocking (50-100 KV) to propel the fibers with an acceleration of about 100 times the acceleration of gravity. The penetration force of an individual fiber in conventional processes would be about (1G) times the mass of the fiber.

In contrast to some conventional flocking techniques, in embodiments disclosed herein the penetration force is about 100 Gs times the mass of the fiber, therefore providing 100 times the penetration force. Such a force combined with the use of a thin sizing layer or an uncured soft epoxy resin causes the fibers to contact the filament yarns at the top and sides, as well as to enter or penetrate the substrate through the interstices below a top surface of the fibrous laminar base-ply substrate. These flocking processes take advantage of the open porosity and breathability of these thinly resin coated and sized fibrous structures or the soft uncured epoxy resin. These processes provide a suction or vacuum force that (during the flocking process) which sucks the impinging fibers deeper into the fibrous laminar base-ply substrate's interstices and spaces; shaking or vibrating the fibrous mass also causes the interstices to oscillate/move back-and-forth and therefore allows the impinging reinforcing fibers 110 to be embedded more deeply into the fibrous laminar base-ply substrate's interstices.

(c) Attaching the Reinforcing Fibers:

After the flocking procedure, the flocked fibrous layer is cured (i.e., curing the adhesive sizing) undisturbed on a flat surface. In one embodiment, this is done at room temperature. After a quiescent “setting” period, that could last, for example, up to 16 hours, the flocked on reinforcing fibers 110 should be attached to the fibrous laminar base-ply substrate 130. The flocked surface is then vacuumed to remove any loose, unattached reinforcing fibers. Finally, in one embodiment, these vacuumed “pre-flocked” surfaces are then transferred to an oven cure for a final cure (or solvent evaporation). This oven cure evaporates off solvent to increase the strength of attachment of the Z-Axis reinforcing fibers 110 to the fibrous laminar base-ply substrate's structure. The pre-flocked composite fiber composite reinforcement layer 100 is then ready for packing and storage.

(d) Packing and Storing “Pre-Flocked Fibrous Reinforcement Layers:

In one embodiment, after the final curing step the material is ready to be cut into inventory-able sheets or carefully rolled up into a loose coil. In some embodiment, the pre-flocked surfaces are kept separated from each other using a release sheet 104. The release sheet 104, similar to release paper or polymer film is used to separate the “dry” stacked up pre-flocked layers. Care is taken not to stack the pre-flocked layers too high so as to “Crush” the Z-Axis oriented reinforcing fibers 110. These pre-flocked fibrous reinforcement sheets are treated with care and not submitted to abrasion or rough touching. The attached reinforcing fibers 110 are attached to the fibrous laminar base-ply substrate 130 with a minimum of adhesive sizing as to not adversely affect the chemical make-up, fibrous porosity, mesh or mat openness and mechanical integrity of the final composite's matrix resin. The thin pre-flock adhesive sizing coatings also help in assuring that the lay-up flexibility of the fibrous composite reinforcement layer material will not be adversely affected. It is desirable that the lay-up flexibility of these Pre-Flocked reinforcement layers be similar to non-pre-flocked reinforcement layer material.

(e) Pre-Flock Storing and Shipping Separator/Release Sheet Material:

Pre-Flocked materials are stored and shipped in either flat sheet or roll form. The release sheet 104is placed between the stacked or rolled up Pre-Flocked sheets. In one embodiment, thin, light-weight fabric or film material that is lightly flocked with longer, stiff fibers is used as the release sheet during the storage and shipping of the pre-flocked structured fiber reinforced layer. The release sheet materials include, but are not limit to, a light weight polyester or nylon nonwoven fabric base and a base nonwoven fabric will be flocked with 40 to 60 Denier Polyester or nylon fibers. The length of these flocked fibers on the release sheet are, in one embodiment, at least 25 percent longer than the length of the reinforcing fibers. The flock density of the flocked release sheet is in the range of 2 to 50 fibers per square millimeter. The flock adhesive for the release sheet can be flexible water based acrylic or polyurethane based. In another embodiment, the release sheet is coated or finished with a chemical release coat (e.g., silicone, fluorocarbon) as a final treatment. This assures that there is an easy release from the structured fiber reinforced layers. The release sheets described above are generally re-useable and low cost. Generally the release sheets protect the pre-flocked structured fiber reinforced layer from being crushed or damaged during warehouse storage and material shipping. The long-stiff and sparsely positioned release sheet fibers penetrate the pre-flocked structured fiber reinforced layers and serve as a stand-off to protect against any damaging abrasions and compressions that might occur during the handling, storage and shipping of pre-flocked structured fiber reinforced layers.

### Pre-flocked Type 2

These TYPE 2 structured fiber reinforced layers are fabricated using epoxy pre-preg composite reinforcement ply layer structures. The primary types of reinforcing fibers that in pre-preg composite reinforcement ply layer structures include, but are not limited to, glass, carbon and polyaramid (Kevlar®) based textile fibers and yarns impregnated with “B” staged epoxy resin. In one embodiment, an uncured softened B-staged epoxy matrix outer surface having a lower viscosity forms a tacky surface to receive embedded reinforcing fibers. These pre-preg reinforcing fibers or yarns imbedded in the “B” staged epoxy resin can be positioned in the resin as unidirectional yarn, woven fabric or chopped fiber mat type fiber reinforcement geometry. Reinforcing fibers that can be used for z-axis flocking include, but are not limited to, nylon, polyester, carbon, graphite, polyolefin and metal.

### Type 2 Pre-flocked Preparation Methodology

### Steps in Preparing Pre-Flocked Type 2 Composite Reinforcement Layers:

(a) Heating the pre-preg composite reinforcement ply layer structure (also referred to as just pre-preg) to lower the epoxy viscosity:

In one embodiment, the pre-preg is heated to temperatures limited to 55° C. and is later cooled down to its storage temperature where it retains its partially cured properties and can still be formed into a composite laminate. When uniformly heated between 45° C-55° C. the pre-preg become tacky and is an ideal substrate for flocking. In one embodiment, a layer of the pre-preg in a desiccated plastic bag was removed from a -20° C. freezer and allowed to reach room temperature. The pre-preg layer is fixed in a griddle type apparatus and heated to 50° C. to ease flock penetration into the carbon fiber/pre-preg substrate.

(b) Applying Fibers to the Tacky Substrate:

in one embodiment, after the carbon fiber/pre-preg layer is heated it is almost immediately attached to the ceiling of an up-flocking apparatus (i.e., applying fibers from below) and the flock is applied at two density levels, 20 fibers/mm² and 50 fibers/mm². Any loose fibers are removed by orienting the layer, flock side down, and shaking it vigorously. The flocked layer is then fixed in a cardboard frame to isolate it from damage and almost immediately placed back in the freezer. The procedures can be repeated for additional layers. In one embodiment, a unidirectional carbon prepreg IM7/977-3 that is infused with a B-stage epoxy resin system CYCOM 977-3 is flocked with a 3 denier, 1.22 mm long nylon fiber. The pre-preg remains “tacky” up to 270° F. (132° C.) and can be cured at 350° F. (177° C.) for six hours. The viscosity of the epoxy system is a function of temperature.

(c) Packing and Storing “Pre-Flocked Fibrous Reinforcement Layers:

the procedures for packing and storing are similar to the procedures described above in conjunction with the TYPE 1 structured fiber reinforced layers. After flocking is performed, the pre-preg material is covered with a release sheet and almost immediately cooled and frozen so as to stop any further thermal cure of the “B” staged epoxy matrix resin. These Type 2 pre-flocked materials are kept frozen (e.g., below 15° C.) after flocking and during subsequent storage and shipping. Keeping these pre-preg materials in a frozen state prevents the latent curing epoxy matrix resin of the composite from curing pre-maturely. The thermal aging history of pre-pregs is a very important issue because the more “heat history” the (latent cure) epoxy resin matrix resin is subjected to, the shorter the pre-preg's workable shelf life will be.

In one exemplary manufacturing technique, a manufacturer of Pre-Preg materials applies Z-Axis fibers to the surface of a pre-preg at the end of a manufacturing run. This technique introduces reinforcing fibers to pre-preg composite reinforcement materials. Applying reinforcing fibers to the surface of pre-preg at the time of initial manufacture is an effective and practical way of preparing “Pre-Flocked” pre-preg without subjection the latent curing epoxy matrix resin to the additional pre-preg heating stage to apply the flock. Other manufacturing techniques include both up-flocking and down-flocking, using a dilute solvent-based dip-able resin/lacquer.

In another process, the pre-flocked pre-preg layer reinforcement fiber is applied directly during the original manufacture of the B-stage epoxy resin pre-preg material; right on the pre-preg production line. Here the flocking operation would be carried out in a direct processing line with the manufacture of the pre-preg. The flocking process would occur at the stage where the pre-preg's reinforcing fibers or fabric have just been coated with the B-Stage epoxy matrix resin while the matrix resin is still warm and viscous and would accept impinging flock fibers. Following this step would be the cooling and eventual freezing of the now pre-flocked pre-preg layer material.

A desired number of pre-flocked reinforcing fiber base fabric pre-form layers can be coated with an uncured, fluid matrix resin and assembled together and consolidated and cured creating a Z-Axis oriented fiber reinforced organic polymer laminar composite structure having an enhanced shear strength and toughness. The desired number of flocked fiber coated epoxy pre-preg layers are assembled together and consolidated by vacuum bagging or hot press consolidation creating a Z-Axis oriented fiber reinforced pre-preg layered organic polymer laminar composite structure.

One skilled in the art will appreciate further features and advantages of the present disclosure based on the above-described embodiments. Accordingly, the present disclosure is not to be limited by what has been particularly shown and described, except as indicated by the appended claims. All publications and references cited herein are expressly incorporated herein by reference in their entirety. What is claimed is:

1. A strength enhancing material ply layer pre-form comprising:
a fibrous laminar base-ply substrate comprising a plurality of crossed elements forming a plurality of interstices;
an adhesive layer disposed on surfaces of the plurality of crossed elements of the fibrous laminar base-ply substrate;
a plurality of reinforcing fibers oriented vertically to a top surface of the fibrous laminar base-ply substrate and embedded into the plurality of interstices formed by the plurality of crossed elements and below the top surface of the fibrous laminar base-ply substrate;
wherein the adhesive layer facilitates embedding the plurality of reinforcing fibers into plurality of interstices;
wherein the plurality of reinforcing fibers are bound to the surfaces of the plurality of crossed elements by the adhesive layer for subsequent composite ply material assembly; and
wherein the fibrous laminar base-ply substrate remains flexible and resin permeable to conform to contour layups.

2. The pre-form of claim 1, wherein the plurality of crossed elements comprise one of:
a plurality of individual filaments;
a plurality of filament yarns;
a plurality of individual filaments and a plurality of filament yarns; and
a plurality of filaments oriented in warp and weft directions.

3. The pre-form of claim 1, wherein the adhesive layer comprises an uncured softened B-staged epoxy matrix outer surface having a lower viscosity forming a tacky surface to receive embedded reinforcing fibers.

4. The pre-form of claim 1, wherein the adhesive layer comprises a thin adhesive sizing layer disposed on surfaces of the fibrous laminar base-ply substrate such that the plurality of interstices remain open to receive embedded reinforcing fibers.

5. The pre-form of claim 4, wherein the thin adhesive sizing layer is a resin and comprises one of:
a sprayable polyurethane lacquer coating;
a sprayable epoxy-based lacquer coating;
a sprayable water based acrylic adhesive;
a dilute water dip-able, water based acrylic adhesive; and
a dilute solvent based dip-able resin/lacquer coating.

6. The pre-form of claim 4, wherein the thin adhesive sizing layer disposed on surfaces of the fibrous laminar base-ply substrate an areal mass density of about 0.00002 gm/mm² to about an areal mass density of about 0.00004 gm/mm².

7. The pre-form of claim 4, wherein the plurality of reinforcing fibers are tacked to side surfaces of the plurality of crossed elements and penetrate the fibrous laminar base-ply substrate.

8. The pre-form of claim 4, wherein each of the plurality of reinforcing fibers is closely bound within a range, from about 0.01 mm to 0.05 mm, to a corresponding surface of at least one of the plurality of crossed elements.

9. The pre-form of claim 4, wherein a thicknesses of the thin adhesive sizing layer ranges from about 0.01 mm to about 0.05 mm.

10. The pre-form of claim 1 wherein the plurality of reinforcing fibers has a flock density of about 70 fibers/mm2 to about 200 fibers/mm² , an average fiber length of about 0.5 mm to about 2.0 mm and an average fiber fineness of about 1.0 denier to about 20 denier.

11. The pre-form of claim 1, wherein the plurality of reinforcing fibers are selected from a group consisting of synthetic fibers, glass fibers, carbon fibers, natural fibers, and metal fibers.

12. The pre-form of claim 1, wherein the plurality of vertically oriented reinforcing fibers are embedded into the interstices of the plurality of crossed elements of the fibrous laminar base-ply substrate to a depth of approximately about 0.05 to about 0.1 mm below the top surface of the fibrous laminar base-ply substrate.

13. The pre-form of claim 1, wherein the plurality of crossed elements form one of:
a woven laminar base-ply substrate;
a non-woven laminar base-ply substrate; and
a knitted laminar base-ply substrate.

14. A method for fabricating a strength enhancing material ply layer pre-form comprising:
applying an adhesive to a dry substrate, the dry substrate comprising a plurality of filament yarns forming a plurality of interstices; and
flocking a plurality of reinforcing fibers onto a first surface of the dry substrate with sufficient force to embed the plurality of reinforcing fibers into the plurality of interstices below a top layer of the dry substrate; and
attaching the plurality of reinforcing fibers to surfaces of the plurality of filament yarns by partially curing the adhesive.

15. The method of claim 14, wherein flocking a plurality of reinforcing fibers further comprises one of:
direct current (DC) high voltage assisted flocking (DCF);
vacuum assisted flocking (VAF);
shaking and vibration assisted flocking (SAF);
alternating current (AC) high voltage combined with SAF;
a combination of VAF and SAF; and
a combination of DCF and SAF; and
wherein the flocking force is greater than the flocking force of ACF.

16. The method of claim 14, wherein the adhesive comprises a resinous flock adhesive sizing comprising one of:
a water based acrylic adhesive;
a sprayable polyurethane lacquer coating;
a sprayable epoxy-based lacquer coating;
a sprayable water based acrylic adhesive;
a dilute water dip-able, water based acrylic adhesive; and
a dilute solvent based dip-able resin/lacquer coating system; and
wherein applying the adhesive comprises spraying the resinous flock adhesive sizing.

17. The method of claim 16, wherein applying a thin coating of resinous flock adhesive sizing to the dry substrate comprises applying uncured resinous flock adhesive sizing at a thickness of about 0.01 mm to about 0.05 mm.

18. The method of claim 14, wherein the adhesive comprises a B-staged epoxy; and
wherein applying the adhesive comprises.

19. The method of claim 14, further comprising applying a release sheet adjacent to free ends of the plurality of reinforcing fibers.
